(19) United States
(12) Patent Application Publication
(10) Pub. No.: US 2026/0084491 A1
(43) Pub. Date: Mar. 26, 2026

(54) HEAT PUMP SYSTEM FOR A VEHICLE

(71) Applicants: HYUNDAI MOTOR COMPANY, Seoul (KR); KIA CORPORATION, Seoul (KR); DOOWON CLIMATE CONTROL CO., LTD., Asan-si (KR)

(72) Inventors: Jeawan Kim, Hwaseong-si (KR); Hochan An, Hwaseong-si (KR); Yeon Ho Kim, Hwaseong-si (KR); Gwi Taek Kim, Hwaseong-si (KR); Hoyoung Jeong, Hwaseong-si (KR); Yeong Jun Kim, Hwaseong-si (KR); Jae Yeon Kim, Hwaseong-si (KR); Man Hee Park, Hwaseong-si (KR); Won Suk Lee, Cheonan-si (KR); Mingyu Lee, Asan-si (KR); Chul Min Kim, Asan-si (KR)

(73) Assignees: HYUNDAI MOTOR COMPANY, Seoul (KR); KIA CORPORATION, Seoul (KR); DOOWON CLIMATE CONTROL CO., LTD., Asan-si (KR)

(21) Appl. No.: 19/217,284

(22) Filed: May 23, 2025

(30) Foreign Application Priority Data
Sep. 24, 2024 (KR) 10-2024-0128972

(51) Int. Cl. B60H 1/32; B60H 1/00; F25B 30/02; F25B 41/31

(52) U.S. Cl. CPC B60H 1/3204; B60H 1/00278; B60H 1/00335; B60H 1/00671; F25B 30/02; F25B 41/31

(57) ABSTRACT

A heat pump system for a vehicle includes a compressor, an HVAC module, a heat-exchanger, a first expansion valve, a first connection line, a chiller, a second expansion valve, a gas injection device, a second connection line, a third connection line, and a fourth connection line. The heat pump system improves cooling and heating performance by applying a gas injection device selectively operating in an air conditioning mode of vehicle interior to increase the flow rate of the refrigerant.

### CROSS-REFERENCE TO RELATED APPLICATION

This application claims priority to and the benefit of Korean Patent Application No. 10-2024-0128972 filed with the Korean Intellectual Property Office on Sep. 24, 2024, the entire contents of which is incorporated herein by reference.

### BACKGROUND OF THE DISCLOSURE

### Technical Field

The present disclosure relates to a heat pump system for a vehicle. More particularly, the present disclosure relates to a heat pump system for a vehicle capable of improving the cooling and heating performance by employing a gas injection device configured to selectively operate in a selected air conditioning mode.

### Description of the Related Art

An air conditioning system for a vehicle includes an air conditioner unit circulating a refrigerant in order to heat or cool an interior of the vehicle.

The air conditioner unit, which maintains the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in summer.

In accordance with a continuous increase in interest in energy efficiency and an environmental pollution problem, the development of an environmentally-friendly vehicle capable of substantially substituting for an internal combustion engine vehicle is required, and the environmentally-friendly vehicle is classified into an electric vehicle driven using a fuel cell or electricity as a power source and a hybrid vehicle driven using an engine and a battery.

In an electric vehicle or a hybrid vehicle among these environmentally-friendly vehicles, a separate heater is not used unlike an air conditioner of a general vehicle, and an air conditioner used in an environmentally-friendly vehicle is generally called a heat pump system.

An electric vehicle driven by the power source of the fuel cell generates driving force by converting the chemical reaction energy between oxygen and hydrogen into electrical energy. In this process, heat energy is generated by a chemical reaction in a fuel cell. Therefore, it is necessary in securing performance of the fuel cell to effectively remove generated heat.

In addition, a hybrid vehicle generates driving force by driving a motor using electricity supplied from the fuel cell described above or an electrical battery, together with an engine operated by a general fuel, such as gasoline. Therefore, heat generated from the fuel cell or the battery and the motor should be effectively removed in order to secure performance of the motor.

Therefore, in a hybrid vehicle or an electric vehicle according to the related art, a cooling means, a heat pump system, and a battery cooling system, respectively, should be configured as separate closed circuits so as to prevent heat generation of the motor, an electric component, and the battery including a fuel cell.

Therefore, a size and a weight of a cooling module disposed at the front of the vehicle are increased, and a layout of connection pipes supplying a refrigerant and a coolant to each of the heat pump system, the cooling means, and the battery cooling system in an engine compartment becomes complicated.

In addition, since a battery cooling system for heating or cooling the battery according to a state of the vehicle is separately provided to obtain an optimal performance of the battery, a plurality of valves for selectively interconnecting connections pipes are employed, and thus noise and vibration due to frequent opening and closing operations of the valves may be introduced into the vehicle interior, thereby deteriorating the ride comfort of the vehicle.

In addition, for heating the vehicle interior, the heating performance may be deteriorated due to the lack of a heat source, the electricity consumption may be increased due to the usage of the electric heater, and the power consumption of the compressor may be increased.

The above information disclosed in this Background section is only for enhancement of understanding of the background of the disclosure, and therefore it may contain information that does not form the prior art that is already known to a person having ordinary skill in the art.

### SUMMARY OF THE DISCLOSURE

The present disclosure provides a heat pump system for a vehicle capable of improving cooling and heating performance by applying a gas injection device selectively operating in an air conditioning mode of vehicle interior to increase the flow rate of the refrigerant.

A heat pump system for a vehicle includes a compressor configured to compress a refrigerant. The heat pump system further includes an HVAC module including an internal condenser and an evaporator connected to the compressor through a refrigerant line, and an opening/closing door configured to adjust an air having passed through the evaporator to be selectively introduced into the internal condenser depending on cooling or heating of a vehicle interior. The heat pump system further includes a heat-exchanger connected to the internal condenser through the refrigerant line, and configured to condense or evaporate the supplied refrigerant by exchanging heat, or heat-exchanging, with air. The heat pump system further includes a first expansion valve provided on, i.e., connected to or along, the refrigerant line between the heat-exchanger and the evaporator, a first connection line disposed between the compressor and the evaporator and having a first end connected to the refrigerant line, and a second end connected to the refrigerant line between the heat-exchanger and the first expansion valve. The heat pump system further includes a chiller provided on the first connection line, and configured to heat-exchange the refrigerant introduced through the first connection line with a selectively introduced coolant to adjust a temperature of the coolant. The heat pump system further includes a second expansion valve provided on the first connection line at an upstream end of the chiller. The heat pumps system further includes a gas injection device connected to the refrigerant line between the internal condenser and the heat-exchanger, and configured to selectively expand the refrigerant supplied from the internal condenser or the heat-exchanger and flow the expanded refrigerant and selectively supply a partial refrigerant among the supplied refrigerant to the compressor so as to increase a flow rate of the refrigerant circulating through the refrigerant line. The heat pump system further includes a second connection line disposed between the heat-exchanger and the first expansion valve and having a first end connected to the refrigerant line and a second end connected to the gas injection device. The heat pump system further includes a third connection line having a first end connected to the second expansion valve, and a second end connected to the refrigerant line between the evaporator and the compressor. The heat pump system further includes a fourth connection line having a first end connected to the refrigerant line between the heat-exchanger and a first end of the second connection line, and a second end connected to the gas injection device.

The gas injection device may include a flash tank configured to separate an interiorly introduced refrigerant into a gaseous refrigerant and a liquid refrigerant and selectively discharge the separated refrigerant. The gas injection device may include a first line having a first end connected to the refrigerant line between the internal condenser and the heat-exchanger, and a second end connected to the flash tank. The gas injection device may include a third expansion valve provided on the first line, a second line connecting the compressor and the flash tank, and configured to selectively supply the gaseous refrigerant from the flash tank to the compressor. The gas injection device may include a third line having a first end connected to the flash tank. The gas injection device may include a fourth expansion valve connected to a second end of the third line and a second end of the second connection line, respectively, and configured to selectively expand the refrigerant discharged the flash tank to the third line.

The fourth expansion valve may be configured to selectively expand the refrigerant supplied from the flash tank and supply the expanded refrigerant to the heat-exchanger, or supply the refrigerant supplied from the flash tank to the first expansion valve, the second expansion valve, or a combination thereof, without expansion.

The third and the fourth expansion valves may be configured to selectively operate in a cooling mode, a heating mode, or a heating and dehumidifying mode of the vehicle interior, and selectively expand the refrigerant while controlling the flow direction of the supplied refrigerant.

The flash tank may operate when the expanded refrigerant is supplied from the third expansion valve through the first line, and supply a gaseous refrigerant among the supplied refrigerant to the compressor through the second line, to increase the flow rate of the refrigerant circulating through the refrigerant line.

A second end of the fourth connection line may be connected to the third expansion valve.

A heat pump system may further include a fifth connection line having a first end connected to the fourth expansion valve, and a second end connected to the refrigerant line at a downstream end of the heat-exchanger. The heat pump system may further include a first valve provided on the refrigerant line between the internal condenser and the heat-exchanger, and a second valve provided on the refrigerant line between the first end of the second connection line and a first end of the fourth connection line.

When the gas injection device is operated, and cooling of a battery module is required in a cooling mode of the vehicle interior, a portion of the refrigerant line connecting the internal condenser and the heat-exchanger may be opened by the first valve. A portion of the refrigerant line connecting a first end of the fourth connection line and the first end of the second connection line may be closed by the second valve. A portion of the first line connecting the refrigerant line to the third expansion valve may be closed. A remaining portion of the first line connecting the third expansion valve to the flash tank may be opened. The second line may be opened, the third line may be opened by the fourth expansion valve, the first connection line may be opened by the second expansion valve, the second connection line may be opened by the fourth expansion valve, the third connection line may be closed by the second expansion valve, and the fourth connection line may be opened by the third expansion valve. The fifth connection line may be closed by the fourth expansion valve, the first expansion valve may expand the refrigerant introduced through the second connection line and a portion of the refrigerant line from the flash tank, and may supply the expanded refrigerant to the evaporator. The second expansion valve may expand the refrigerant introduced through the second connection line, a portion of the refrigerant line, and the first connection line, and supply the expanded refrigerant to the chiller. The third expansion valve may expand the refrigerant introduced through a portion of the refrigerant line and the fourth connection line from the heat-exchanger, and may supply the expanded refrigerant to the first line. The fourth expansion valve may flow the refrigerant supplied from the flash tank through the third line and to the second connection line without expansion. The flash tank may supply the gaseous refrigerant among the interiorly introduced refrigerant to the compressor through the opened second line.

When the gas injection device is operated and a waste heat of an electrical component is recollected in a heating mode of the vehicle interior, a portion of the refrigerant line connecting a first end of the first line to the heat-exchanger may be closed by the first valve. A portion of the refrigerant line connecting a first end of the first connection line to the compressor may be opened. A portion of the refrigerant line connecting a second end of the first connection line to the evaporator may be closed by the first expansion valve. A portion of the refrigerant line connecting the evaporator and the first end of the first connection line may be closed. A portion of the refrigerant line connecting the heat-exchanger and the first end of the second connection line may be closed by the second valve. The first line may be opened by the third expansion valve. The second line may be opened, the third line may be opened by the fourth expansion valve, the first connection line may be opened by the second expansion valve, the second connection line may be opened by the fourth expansion valve, and the third connection line may be closed by the second expansion valve. The fourth connection line may be closed by the third expansion valve, the fifth connection line may be closed by the fourth expansion valve, and an operation of the first expansion valve may be stopped. The second expansion valve may expand the refrigerant introduced from the flash tank through the second connection line, a portion of the refrigerant line, and the first connection line, and may supply the expanded refrigerant to the chiller. The third expansion valve may expand the refrigerant supplied from the internal condenser, and may supply the expanded refrigerant to the flash tank through the first line. The fourth expansion valve may flow the refrigerant supplied from the flash tank through the third line and to the second connection line without expansion. The flash tank may supply the gaseous refrigerant among the interiorly introduced refrigerant to the compressor through the opened second line.

When the gas injection device is operated and an ambient air heat is to be recollected in a heating mode of the vehicle interior, a portion of the refrigerant line connecting a first end of the first line to a second end of the fifth connection line may be closed by the first valve. A portion of the refrigerant line connecting the heat-exchanger and a second end of the first connection line may be opened by the second valve. A portion of the refrigerant line connecting the second end of the first connection line to the evaporator may be closed by the first expansion valve. A portion of the refrigerant line connecting the evaporator to a second end of the third connection line may be closed. A portion of the refrigerant line connecting the second end of the third connection line to the compressor may be opened. The first line may be opened by the third expansion valve, the second line may be opened, and the third line may be opened by the fourth expansion valve. A portion of the first connection line connecting the refrigerant line and the second expansion valve may be opened by the second expansion valve. A remaining portion of the first connection line connecting the refrigerant line and the chiller connected to the compressor may be closed by the second expansion valve. The second connection line may be closed by the fourth expansion valve, the third connection line may be opened by the second expansion valve, the fourth connection line may be closed by the third expansion valve, and the fifth connection line may be opened by the fourth expansion valve. An operation of the first expansion valve may be stopped. The second expansion valve may flow the refrigerant introduced through a portion of the refrigerant line and the first connection line from the heat-exchanger to the third connection line without expansion. The third expansion valve may expand the refrigerant supplied from the internal condenser, and may supply the expanded refrigerant to the flash tank through the first line. The fourth expansion valve may expand the refrigerant supplied from the flash tank through the third line, and may flow the expanded refrigerant to the fifth connection line. The flash tank may supply the gaseous refrigerant among the interiorly introduced refrigerant to the compressor through the opened second line.

When the gas injection device is operated and a waste heat of an electrical component and an ambient air heat are recollected together in a heating mode of the vehicle interior, a portion of the refrigerant line connecting a first end of the first line to a second end of the fifth connection line may be closed by the first valve. A portion of the refrigerant line connecting the heat-exchanger and a second end of the first connection line may be opened by the second valve. A portion of the refrigerant line connecting the second end of the first connection line to the evaporator may be closed by the first expansion valve. A portion of the refrigerant line connecting the evaporator to a first end of the first connection line may be closed. A portion of the refrigerant line connecting the first end of the first connection line to the compressor may be opened. The first line may be opened by the third expansion valve, the second line may be opened, the third line may be opened by the fourth expansion valve, the first connection line may be opened by the second expansion valve, the second connection line may be closed by the fourth expansion valve, and the third connection line may be closed by the second expansion valve. The fourth connection line may be closed by the third expansion valve, and the fifth connection line may be opened by the fourth expansion valve. An operation of the first expansion valve may be stopped. The second expansion valve may supply the refrigerant introduced through a portion of the refrigerant line and the first connection line from the heat-exchanger to the chiller without expansion. The third expansion valve may expand the refrigerant supplied from the internal condenser, and may supply the expanded refrigerant to the flash tank through the first line. The fourth expansion valve may expand the refrigerant supplied from the flash tank through the third line, and may flow the expanded refrigerant to the fifth connection line. The flash tank may supply the gaseous refrigerant among the interiorly introduced refrigerant to the compressor through the opened second line.

When the gas injection device is operated in a heating and dehumidifying mode of the vehicle interior, a portion of the refrigerant line connecting the evaporator and the compressor may be opened. A portion of the refrigerant line connecting a second end of the first connection line to the evaporator may be opened by the first expansion valve. A portion of the refrigerant line connecting a first end of the first line to the heat-exchanger may be closed by the first valve. A portion of the refrigerant line connecting the heat-exchanger and the first end of the second connection line may be closed by the second valve. The first line may be opened by the third expansion valve, the second line may be opened, and the third line may be opened by the fourth expansion valve. The first connection line may be opened by the second expansion valve, the second connection line may be opened by the fourth expansion valve, the third connection line may be closed by the second expansion valve, the fourth connection line may be closed by the third expansion valve, and the fifth connection line may be closed by the fourth expansion valve. The first expansion valve may expand the refrigerant introduced through the second connection line and a portion of the refrigerant line from the flash tank, and may supply the expanded refrigerant to the evaporator. The second expansion valve may expand the refrigerant introduced through the first connection line, and may supply the expanded refrigerant to the chiller. The third expansion valve may expand the refrigerant supplied from the internal condenser, and may supply the expanded refrigerant to the flash tank through the first line. The fourth expansion valve may flow the refrigerant supplied from the flash tank through the third line and to the second connection line without expansion. The flash tank may supply the gaseous refrigerant among the interiorly introduced refrigerant to the compressor through the opened second line.

When the gas injection device is not operated in a heating and dehumidifying mode of the vehicle interior, a portion of the refrigerant line connecting the evaporator and the compressor may be opened. A portion of the refrigerant line connecting a second end of the first connection line to the evaporator may be opened by the first expansion valve. A portion of the refrigerant line connecting a first end of the first line to the heat-exchanger may be closed by the first valve. A portion of the refrigerant line connecting the heat-exchanger to a first end of the fourth connection line may be closed. A portion of the refrigerant line connecting the first end of the fourth connection line to the first expansion valve may be opened by the second valve. A portion of the first line may be opened by the third expansion valve so that the internal condenser may be connected to the third expansion valve. A remaining portion of the first line connecting the flash tank and the third expansion valve may be closed by the third expansion valve. The second line may be closed, the third line may be closed by the fourth expansion valve, the first connection line may be opened by the second expansion valve, and the second connection line may be closed by the fourth expansion valve. The third connection line may be closed by the second expansion valve, the fourth connection line may be opened by the third expansion valve, and the fifth connection line may be closed by the fourth expansion valve. The first expansion valve may expand the refrigerant introduced from the internal condenser through a portion of the first line, the fourth connection line, and a portion of the refrigerant line, and may supply the expanded refrigerant to the evaporator. The second expansion valve may expand the refrigerant introduced through the first connection line, and may supply the expanded refrigerant to the chiller. The third expansion valve may flow the refrigerant supplied from the internal condenser to the fourth connection line without expansion. Operations of the flash tank and the fourth expansion valve may be stopped.

While the gas injection device is operated, when an ambient air heat is to be recollected in a heating mode of the vehicle interior or when a waste heat of an electrical component and the ambient air heat are recollected together in the heating mode of the vehicle interior, the fifth connection line may be opened by the fourth expansion valve.

The second expansion valve, the third expansion valve, and the fourth expansion valve may be 3-way electronic expansion valves configured to selectively expand the refrigerant while controlling the flow direction of the refrigerant.

When the gas injection device is operated in a cooling mode of the vehicle interior or when the gas injection device is not operated in a heating and dehumidifying mode of the vehicle interior, the fourth connection line may be opened by an operation of the third expansion valve.

A heat pump system may further include a sub-heat-exchanger connected to the second connection line and the refrigerant line connecting the evaporator and the compressor, and be configured to heat-exchange the refrigerant supplied through the second connection line and the refrigerant supplied from the evaporator or the chiller with each other.

When an ambient air heat is recollected in a heating mode of the vehicle interior, the third connection line may be selectively opened by the second expansion valve.

A heat pump system may further include a cooling apparatus including an electrical component and a battery module through which the coolant circulates, where the chiller is connected to the electrical component through a first coolant line through which the coolant circulates, and connected to the battery module through a second coolant line through which the coolant circulates.

The first coolant line may be opened to connect the chiller and the electrical component, when a waste heat of the electrical component is to be recollected in a heating mode of the vehicle interior, and the second coolant line may be opened to connect the chiller and the battery module, when the battery module is to be cooled in a cooling mode of the vehicle, or when a waste heat of the battery module is recollected in the heating mode of the vehicle interior.

As described above, according to a heat pump system for a vehicle according to an embodiment of the present disclosure, cooling and heating performance may be improved by applying a gas injection device selectively operating in an air conditioning mode of vehicle interior to increase the flow rate of the refrigerant.

In addition, according to the present disclosure, the performance of the system by using the gas injection device may be maximized while minimizing the required system components, and accordingly, streamlining and simplification of the system may be achieved.

In addition, according to the present disclosure, through streamlining of an entire system, it is possible to reduce manufacturing cost and weight and improve space utilization of a vehicle or a system for the vehicle.

### BRIEF DESCRIPTION OF THE DRAWINGS

FIG. 1 is a block diagram illustrating a heat pump system for a vehicle according to an embodiment of the present disclosure.

FIG. 2 is an operation diagram of a heat pump system for a vehicle according to an embodiment of the present disclosure, in which a gas injection device is operated and a battery module is cooled in a cooling mode of the vehicle interior.

FIG. 3 is an operation diagram of a heat pump system for a vehicle according to an embodiment of the present disclosure, in which a gas injection device is operated and a waste heat of the electrical component is recollected in a heating mode of the vehicle interior.

FIG. 4 is an operation diagram of a heat pump system for a vehicle according to an embodiment of the present disclosure, in which a gas injection device is operated and an ambient air heat is recollected in a heating mode of the vehicle interior.

FIG. 5 is an operation diagram of a heat pump system for a vehicle according to an embodiment of the present disclosure, in which a gas injection device is operated and a waste heat of the electrical component and the ambient air heat is recollected in a heating mode of the vehicle interior.

FIG. 6 is an operation diagram of a heat pump system for a vehicle according to an embodiment of the present disclosure, in which a gas injection device is operated in a heating and dehumidifying mode of the vehicle interior.

FIG. 7 is an operation diagram of a heat pump system for a vehicle according to an embodiment of the present disclosure, in which a gas injection device is not operated in a heating and dehumidifying mode of the vehicle interior.

### DETAILED DESCRIPTION

Some embodiments of the present disclosure are hereinafter described in detail with reference to the accompanying drawings.

Embodiments disclosed in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the words “comprise”, “have”, “include” and variations thereof such as “comprises” or “comprising”, should be understood to imply the inclusion of stated elements but not the exclusion of any other elements.

Furthermore, each of terms, such as “ . . . unit”, “ . . . means”, “ . . . portions”, “ . . . part”, and “ . . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

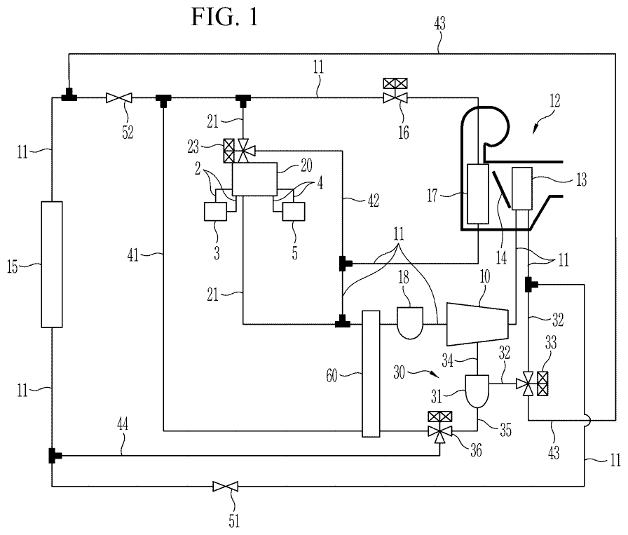

FIG. 1 is a block diagram illustrating a heat pump system for a vehicle according to an embodiment of the present disclosure.

A heat pump system for a vehicle according to an embodiment of the present disclosure may improve the cooling and heating performance by applying a gas injection device 30 that selectively operates in a selected air conditioning mode of a vehicle interior among a cooling mode, a heating mode, or a heating-dehumidifying mode and thereby increasing a flow rate of a refrigerant.

According to the heat pump system, in an electric vehicle, a cooling apparatus through which a coolant circulates and an air conditioner unit, which is an air-conditioner apparatus for cooling and heating the vehicle interior, may be interconnected with each other.

In other words, referring to FIG. 1, the heat pump system may include the cooling apparatus, and the air conditioner unit including a compressor 10, a heating, ventilation, and air-conditioning (HVAC) module 12, an internal condenser 13, a heat-exchanger 15, a first expansion valve 16, an evaporator 17, a chiller 20, a first connection line 21, a second expansion valve 23, the gas injection device 30, a second connection line 41, a third connection line 42, and a fourth connection line 43.

The cooling apparatus may include an electrical component 3 and a battery module 5 through which the coolant circulates.

The cooling apparatus may further include a radiator (not shown). The radiator may be disposed at an upstream end, i.e., a front of the vehicle (relative to the normal driving or movement direction). A cooling fan (not shown) may be provided at a rear of the radiator. Accordingly, the radiator may cool the coolant through an operation of the cooling fan and heat-exchange with ambient air.

The electrical component 3 may be connected to the chiller 20 through a first coolant line 2 through which the coolant circulates. The battery module 5 may be connected to the chiller 20 through a second coolant line 4 through which the coolant circulates.

In other words, the electrical component 3 may be connected to the first coolant line 2, and cooled in a water-cooled manner.

In addition, when the waste heat of the electrical component 3 is to be recollected in the heating mode of the vehicle interior, the first coolant line 2 may be opened to connect the chiller 20 and the electrical component 3.

Accordingly, the chiller 20 may adjust a temperature of the electrical component 3 by using the coolant heat-exchanged with the refrigerant, and may recollect the waste heat of the electrical component 3.

When the battery module 5 is to be cooled in the cooling mode of the vehicle, or when the waste heat of the battery module 5 is to be recollected in the heating mode of the vehicle interior, the second coolant line 4 may be opened to connect the chiller 20 and the battery module 5.

The coolant may selectively circulate through the first coolant line 2 and the second coolant line 4 by a water pump (not shown) to impart flow of the coolant through the coolant lines.

The electrical component 3 may include an electric power control unit (EPCU), a motor, an inverter, an on-board charger (OBC), an autonomous driving controller, or the like.

The electrical power control apparatus, the inverter, the motor, or the autonomous driving controller may generate heat during driving of the vehicle, and the charger may generate heat when charging the battery module 5.

In other words, when the waste heat of the electrical component 3 is to be recollected in the heating mode of the vehicle interior, the heat generated from the electrical power control apparatus, the motor, the inverter, the charger, or the autonomous driving controller may be recollected.

In an embodiment of the present disclosure, the compressor 10 may compress the supplied refrigerant and flow the compressed refrigerant to a refrigerant line 11 so that the refrigerant may circulate along the refrigerant line 11.

The internal condenser 13 and the evaporator 17 connected to the compressor 10 through the refrigerant line 11 may be provided inside the HVAC module 12.

The opening/closing door 14 configured to adjust the ambient air having passed through the evaporator 17 to be selectively introduced into the internal condenser 13 may be provided inside the HVAC module 12 between the evaporator 17 and the internal condenser 13.

When heating the vehicle interior, the opening/closing door 14 may be opened so that the ambient air having passed through the evaporator 17 may be introduced to the internal condenser 13.

In other words, the high-temperature refrigerant supplied to the internal condenser 13 may increase a temperature of the ambient air passing through the internal condenser 13. In other words, the introduced ambient air may be converted to a high-temperature state while passing through the internal condenser 13 and then introduced into the vehicle interior, thereby implementing heating of the vehicle interior.

To the contrary, when cooling the vehicle interior, the opening/closing door 14 may close a side toward the internal condenser 13 so that the ambient air cooled while passing through the evaporator 17 is directly introduced into the vehicle interior.

Accordingly, the ambient air passing through the evaporator 17 may be cooled by the low-temperature refrigerant supplied to the evaporator 17 while passing through the evaporator 17. The cooled ambient air may be introduced into the vehicle interior, thereby cooling the vehicle interior.

In an embodiment of the present disclosure, the heat-exchanger 15 may be connected to the internal condenser 13 through the refrigerant line 11. The heat-exchanger 15 may be disposed at the front of the vehicle.

Accordingly, the heat-exchanger 15 may condense or evaporate the refrigerant by heat-exchanging the introduced refrigerant with the ambient air introduced during driving of the vehicle. In other words, the heat-exchanger 15 may be an air-cooled heat-exchanger configured to heat-exchange the introduced refrigerant with the ambient air.

The first expansion valve 16 may be provided on, i.e., connected to or along, the refrigerant line 11 connecting the heat-exchanger 15 and the evaporator 17. The first expansion valve 16 may selectively expand the introduced refrigerant.

The air conditioner unit may further include an accumulator 18. The accumulator 18 may be provided on the refrigerant line 11 between the evaporator 17 and the compressor 10.

The accumulator 18 may only supply the gaseous refrigerant to the compressor 10, and thereby improve the efficiency and durability of the compressor 10.

In an embodiment of the present disclosure, the chiller 20 may heat-exchange the refrigerant supplied from the air conditioner unit with the coolant, and thereby adjust a temperature of the coolant selectively supplied through the first coolant line 2 or the second coolant line 4.

In other words, the chiller 20 may be a water-cooled heat-exchanger configured to heat-exchange an interiorly introduced refrigerant with the coolant.

The chiller 20 may be connected to the refrigerant line 11 through the first connection line 21.

A first end of the first connection line 21 may be connected to the refrigerant line 11 between the evaporator 17 and the accumulator 18. In addition, a second end of the first connection line 21 may be connected to the refrigerant line 11 between the heat-exchanger 15 and the first expansion valve 16.

The chiller 20 may adjust the temperature of the coolant by heat-exchanging the coolant selectively introduced through the first coolant line 2 or the second coolant line 4 with the refrigerant selectively supplied from the air conditioner unit.

Accordingly, the coolant heat-exchanged with the refrigerant at the chiller 20 may be selectively supplied to the electrical component 3 and the battery module 5, to adjust temperatures of the electrical component 3 and the battery module 5.

The chiller 20 configured as such may be disposed in parallel with the heat-exchanger 15 through the first connection line 21.

In an embodiment of the present disclosure, the second expansion valve 23 may be provided on the first connection line 21 in an upstream end of the chiller 20, based on the flow direction of the refrigerant.

When the electrical component 3 or the battery module 5 is to be cooled by using the coolant heat-exchanged with the refrigerant in the cooling mode of the vehicle interior, the second expansion valve 23 may expand the refrigerant introduced through the first connection line 21 and flow the expanded refrigerant into the chiller 20.

In other words, when the electrical component 3 or the battery module 5 is to be cooled in the cooling mode of the vehicle interior, the second expansion valve 23 may expand the refrigerant introduced through the first connection line 21 to lower its temperature, and flow the expanded refrigerant to the chiller 20, to further lower the temperature of the coolant passing through an interior of the chiller 20.

Accordingly, the coolant cooled while passing through the chiller 20 may be introduced into the electrical component 3 or the battery module 5, thereby achieving more efficient cooling.

The second expansion valve 23 configured as such may be a 3-way electronic expansion valve having one inlet and two outlets and configured to selectively expand the refrigerant while controlling a flow direction of the supplied refrigerant.

The upstream end of the chiller 20 may be set based on the flow direction of the refrigerant. Based on the direction in which the refrigerant flows along the first connection line 21, a location where the refrigerant is introduced into the chiller 20 may be defined as an upstream end of the chiller 20, and a location where the refrigerant is discharged from the chiller 20 may be defined as a downstream end of the chiller 20.

In addition, the gas injection device 30 may be connected to the refrigerant line 11 between the internal condenser 13 and the heat-exchanger 15.

The gas injection device 30 may selectively expand the refrigerant supplied from the internal condenser 13 or the heat-exchanger 15 and flow the expanded refrigerant, and may selectively supply a partial refrigerant among the supplied refrigerant to the compressor 10 to increase the flow rate of the refrigerant circulating through the refrigerant line 11.

The gas injection device 30 configured as such may be selectively operated in the cooling mode, or the heating mode, or the heating and dehumidifying mode of the vehicle.

In an embodiment of the present disclosure, a first end of the second connection line 41 may be connected to the refrigerant line 11 between the heat-exchanger 15 and the first expansion valve 16. A second end of the second connection line 41 may be connected to the gas injection device 30.

A first end of the third connection line 42 may be connected to the second expansion valve 23. A second end of the third connection line 42 may be connected to the refrigerant line 11 between the evaporator 17 and the accumulator 18.

In addition, a first end of the fourth connection line 43 may be connected to the refrigerant line 11 between the heat-exchanger 15 and the first end of the second connection line 41. A second end of the fourth connection line 43 may be connected to the gas injection device 30.

The gas injection device 30 may include a flash tank 31, a first line 32, a third expansion valve 33, a second line 34, a third line 35, and a fourth expansion valve 36.

The flash tank 31 may separate a gaseous refrigerant and a liquid refrigerant from among the interiorly introduced refrigerant and selectively discharge the separated refrigerant (i.e., selectively discharge the gaseous refrigerant and the liquid refrigerant).

A first end of the first line 32 may be connected to the refrigerant line 11 between the internal condenser 13 and the heat-exchanger 15. A second end of the first line 32 may be connected to the flash tank 31.

In an embodiment of the present disclosure, the third expansion valve 33 may be provided on the first line 32. The second end of the fourth connection line 43 may be connected to the third expansion valve 33.

The first line 32 may selectively supply the refrigerant supplied from the internal condenser 13 to the flash tank 31 according to an operation of the third expansion valve 33.

In other words, the third expansion valve 33 may selectively expand the refrigerant introduced from the internal condenser 13 through the first line 32. The third expansion valve 33 may flow the expanded refrigerant or the unexpanded refrigerant to the first line 32 or the fourth connection line 43.

The second line 34 may connect the flash tank 31 and the compressor 10. When the refrigerant is supplied to the flash tank 31, the second line 34 may selectively supply the gaseous refrigerant from the flash tank 31 to the compressor 10.

In other words, the second line 34 may connect the flash tank 31 and the compressor 10 so that the gaseous refrigerant separated at the flash tank 31 may be selectively introduced into the compressor 10.

In an embodiment of the present disclosure, a first end of the third line 35 may be connected to the flash tank 31.

In addition, a second end of the third line 35 and the second end of the second connection line 41 may be connected to the fourth expansion valve 36, respectively.

The heat pump system may further include a fifth connection line 44.

A first end of the fifth connection line 44 may be connected to the fourth expansion valve 36. A second end of the fifth connection line 44 may be connected to the refrigerant line 11 at a downstream end of the heat-exchanger 15.

The fourth expansion valve 36 may selectively expand the refrigerant discharged from the flash tank 31 to the third line 35 so that the expanded refrigerant may be supplied to the heat-exchanger 15 through the fifth connection line 44.

The fourth expansion valve 36 may supply the refrigerant supplied from the flash tank 31 through the third line 35, to one or all of the first expansion valve 16 and the second expansion valve 23, without expansion.

The third expansion valve 33 and the fourth expansion valve 36 may be selectively operated in the air conditioning mode of the vehicle interior including the cooling mode, the heating mode, or the heating and dehumidifying mode of the vehicle interior, and may selectively expand the refrigerant while controlling the flow direction of the refrigerant supplied to the gas injection device 30.

In other words, the third expansion valve 33 and the fourth expansion valve 36 may be 3-way electronic expansion valves having one inlet and two outlets and configured to selectively expand the refrigerant while controlling the flow direction of the refrigerant.

In the gas injection device 30 configured as such, the flash tank 31 may operate when the expanded refrigerant is supplied in the air conditioning mode of the vehicle interior.

In other words, the flash tank 31 may operate when the expanded refrigerant is supplied from the third expansion valve 33 through the first line 32. The flash tank 31 may supply the gaseous refrigerant among the supplied refrigerant to the compressor 10 through the second line 34, to increase the flow rate of the refrigerant circulating through the refrigerant line 11.

When the gas injection device 30 is operated in the cooling mode of the vehicle interior, or in the case in which the gas injection device 30 is not operated in the heating and dehumidifying mode of the vehicle interior, the fourth connection line 43 may be opened by the operation of the third expansion valve 33.

In addition, while the gas injection device 30 is operated, when the ambient air heat is to be recollected in the heating mode of the vehicle interior, or when the waste heat of the electrical component and the ambient air heat is to be recollected together in the heating mode of the vehicle interior, the fifth connection line 44 may be opened by the fourth expansion valve 36.

In addition, when the ambient air heat is to be recollected in the heating mode of the vehicle interior, the third connection line 42 may be selectively opened by the second expansion valve 23.

In other words, the second expansion valve 23 may open the third connection line 42 so that the refrigerant introduced through the refrigerant line 11 and the first connection line 21 from the heat-exchanger 15 is supplied to the accumulator 18 without passing through the chiller 20.

The second expansion valve 23 may flow the introduced refrigerant without expansion.

When the waste heat generated from the electrical component 3 or the battery module 5 is to be recollected in the heating mode of the vehicle interior, the second expansion valve 23 may open the first connection line 21 connected to the chiller 20, and may close the third connection line 42. In this case, the second expansion valve 23 may expand the refrigerant introduced through the first connection line 21, and may supply the expanded refrigerant to the chiller 20.

Accordingly, the chiller 20 may evaporate the refrigerant through heat-exchange with the coolant supplied through the first coolant line 2 or the second coolant line 4.

The chiller 20 may recollect the waste heat of the electrical component 3 or the battery module 5 while heat-exchanging the refrigerant supplied from the second expansion valve 23 with the coolant supplied from the electrical component 3 or the battery module 5.

Even when the waste heat generated from the electrical component 3 or the battery module 5 is to be recollected together with the ambient air heat, the second expansion valve 23 may open the first connection line 21 connected to the chiller 20, and may close the third connection line 42.

As the refrigerant expanded at the fourth expansion valve 36 passes through the heat-exchanger 15 and then may be introduced into the first connection line 21, the second expansion valve 23 may flow the introduced refrigerant without expansion.

Accordingly, the heat-exchanger 15 may evaporate the refrigerant while heat-exchanging the ambient air and the refrigerant supplied from the fourth expansion valve 36. The refrigerant may directly absorb the ambient air heat from the ambient air while passing through the heat-exchanger 15.

Thereafter, the chiller 20 may additionally evaporate the refrigerant through heat-exchange with the coolant supplied through the first coolant line 2 or the second coolant line 4.

The refrigerant may recollect the waste heat of the electrical component 3 or the battery module 5 through heat-exchange with the coolant supplied from the electrical component 3 or the battery module 5 while passing through the chiller 20.

The heat pump system may further include a first valve 51 and a second valve 52.

The first valve 51 may be provided on the refrigerant line 11 between the internal condenser 13 and the heat-exchanger 15.

In addition, the second valve 52 may be provided on the refrigerant line 11 between the first end of the second connection line 41 and the second end of the fourth connection line 43.

The first valve 51 and the second valve 52 may each be configured as a 2-way valve, and may selectively open and close the refrigerant line 11 to control the flow direction of the refrigerant in the selected air conditioning mode of the vehicle.

The heat pump system configured as such may further include a sub-heat-exchanger 60.

The sub-heat-exchanger 60 may be connected to the second connection line 41 and the refrigerant line 11 connecting the evaporator 17 and the compressor 10, respectively.

The sub-heat-exchanger 60 may heat-exchange the refrigerant supplied through the second connection line 41 and the refrigerant supplied from the evaporator 17 or the chiller 20 with each other.

The sub-heat-exchanger 60 may be a double-tube heat-exchanger or a plate-type heat-exchanger configured to heat-exchange the refrigerants having different temperatures with each other.

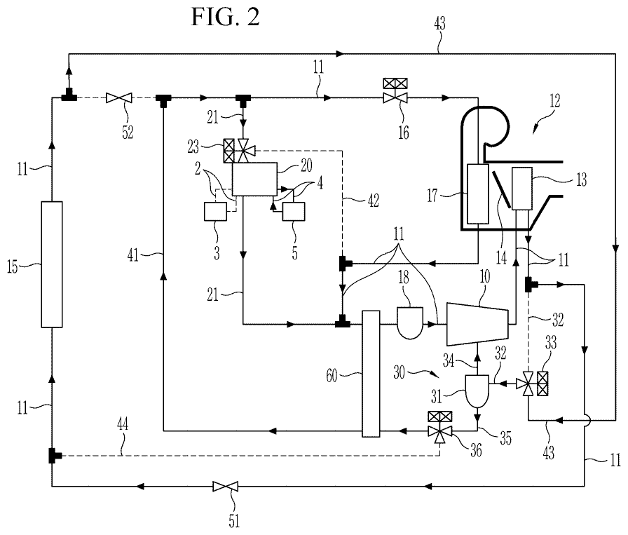

An operation and action of a heat pump system according to an embodiment of the present disclosure configured as such are described in detail below with reference to FIGS. 2-7.

An operation of a heat pump system for a vehicle, according to an embodiment of the present disclosure, when the gas injection device 30 is operated, and cooling of the battery module 5 is required in the cooling mode of the vehicle interior, is described in detail below with reference to FIG. 2.

FIG. 2 is an operation diagram of a heat pump system for a vehicle according to an embodiment of the present disclosure when the gas injection device is operated and the battery module is to be cooled in the cooling mode of the vehicle interior.

Referring to FIG. 2, a portion of the refrigerant line 11 connecting the internal condenser 13 and the heat-exchanger 15 may be opened by the first valve 51.

In addition, a portion of the refrigerant line 11 connecting the first end of the fourth connection line 43 and the first end of the second connection line 41 may be closed by the second valve 52.

In addition, a portion of the first line 32 connecting the refrigerant line 11 to the third expansion valve 33 may be closed.

A remaining portion of the first line 32 connecting the third expansion valve 33 to the flash tank 31 may be opened. In addition, the second line 34 may be opened.

In an embodiment of the present disclosure, the third line 35 may be opened by the fourth expansion valve 36.

The first connection line 21 may be opened by the second expansion valve 23. The second connection line 41 may be opened by the fourth expansion valve 36.

The second expansion valve 23 may expand the refrigerant introduced through the second connection line 41, the portion of the refrigerant line 11, and the first connection line 21, and supply the expanded refrigerant to the chiller 20.

The third connection line 42 may be closed by the second expansion valve 23. In addition, the fourth connection line 43 may be opened by the third expansion valve 33. In addition, the fifth connection line 44 may be closed by the fourth expansion valve 36.

Accordingly, the refrigerant discharged from the internal condenser 13 may be introduced into the heat-exchanger 15 along the opened refrigerant line 11. The heat-exchanger 15 may condense the supplied refrigerant through heat-exchange with the ambient air.

The refrigerant having passed through the heat-exchanger 15 may be supplied to the third expansion valve 33 along the fourth connection line 43.

The third expansion valve 33 may expand the refrigerant introduced through the portion of the refrigerant line 11 and the fourth connection line 43 from the heat-exchanger 15. Thereafter, the third expansion valve 33 may supply the expanded refrigerant to the flash tank 31 through the opened first line 32.

Accordingly, the expanded refrigerant may be introduced into the flash tank 31. The flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34, to increase the flow rate of the refrigerant circulating through the refrigerant line 11.

The liquid refrigerant stored in the flash tank 31 may flow along the third line 35 and the second connection line 41 opened through an operation of the fourth expansion valve 36.

The fourth expansion valve 36 may flow the refrigerant supplied from the flash tank 31 through the third line 35 to the second connection line 41 without expansion.

The refrigerant flowing along the second connection line 41 may pass through the sub-heat-exchanger 60.

A partial refrigerant among the refrigerant having passed through the sub-heat-exchanger 60 may be introduced into the second expansion valve 23 along the second connection line 41, a portion of the refrigerant line 11, and the first connection line 21.

The second expansion valve 23 may expand the refrigerant introduced through the first connection line 21. Thereafter, the second expansion valve 23 may supply the expanded refrigerant to the chiller 20.

The refrigerant introduced into the chiller 20 may cool the coolant while heat-exchanging with the coolant supplied from the battery module 5 through the second coolant line 4.

The coolant cooled at the chiller 20 may be supplied to the battery module 5 along the second coolant line 4. Accordingly, the battery module 5 may be efficiently cooled by the coolant cooled at the chiller 20.

In other words, the coolant circulated through the second coolant line 4 may efficiently cool the battery module 5 while repeatedly performing the above-described operation.

A remaining refrigerant excluding the refrigerant introduced into the first connection line 21 among the refrigerant having passed through the sub-heat-exchanger 60 may be introduced into the first expansion valve 16 along the refrigerant line 11.

The first expansion valve 16 may expand the introduced refrigerant and supply the expanded refrigerant to the evaporator 17.

The ambient air introduced into the HVAC module 12 may be cooled while passing through the evaporator 17 by the low-temperature refrigerant introduced into the evaporator 17.

The opening/closing door 14 may close a portion to pass through the internal condenser 13 so that the cooled ambient air does not pass through the internal condenser 13. Therefore, the cooled ambient air may cool the vehicle interior by being directly introduced into the vehicle interior.

The refrigerant having passed through the evaporator 17 and the chiller 20, respectively, may pass through the sub-heat-exchanger 60 along the refrigerant line 11.

The sub-heat-exchanger 60 may additionally condense the refrigerant supplied from the flash tank 31 through the third line 35 and the second connection line 41 through heat-exchange with the refrigerant supplied from the evaporator 17 and the chiller 20, respectively.

The refrigerant supplied from the evaporator 17 and the chiller 20 and having passed through the sub-heat-exchanger 60 may be introduced into the accumulator 18 along the refrigerant line 11. Thereafter, the refrigerant may pass through the accumulator 18 and be introduced into the compressor 10.

In other words, the refrigerant having passed through the accumulator 18, and the refrigerant supplied from the flash tank 31 through the second line 34 may be introduced into the compressor 10. The introduced refrigerant may be compressed by the compressor 10.

The refrigerant compressed at the compressor 10 may pass through the internal condenser 13, and then may be supplied to the heat-exchanger 15 along the refrigerant line 11.

The heat pump system may repeatedly perform the above-described processes.

In other words, the heat pump system may increase the flow rate of the refrigerant flowing along the refrigerant line 11 while repeatedly performing the above-described operation.

In addition, the heat pump system may increase the flow rate of the refrigerant flowing along the refrigerant line 11 to improve the overall cooling performance and efficiency, and to efficiently cool the vehicle interior.

The heat pump system may efficiently cool the battery module 5 by using the low-temperature coolant cooled at the chiller 20.

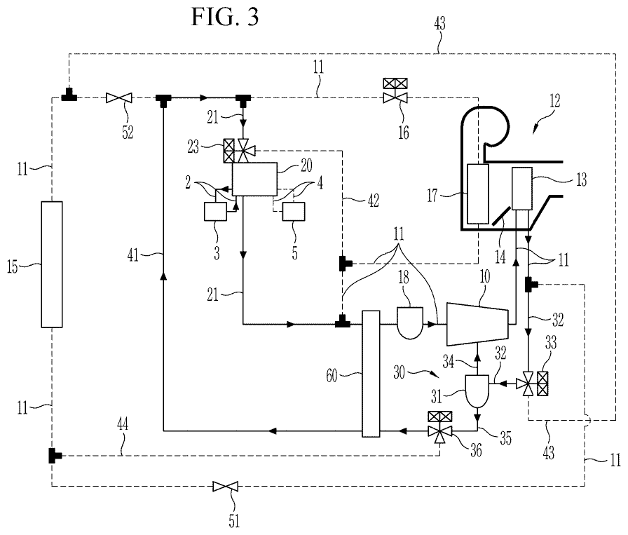

An operation of a heat pump system for a vehicle according to an embodiment of the present disclosure when the gas injection device 30 is operated and the waste heat of the electrical component 3 is to be recollected in the heating mode of the vehicle interior is described in detail below with reference to FIG. 3.

FIG. 3 is an operation diagram of a heat pump system for a vehicle according to an embodiment of the present disclosure when the gas injection device is operated and the waste heat of the electrical component is to be recollected in the heating mode of the vehicle interior.

Referring to FIG. 3, the heat pump system may recollect the waste heat of the electrical component 3 while the gas injection device 30 is operated.

In other words, when the gas injection device 30 is operated in the heating mode of the vehicle interior, the operation of the first expansion valve 16 may be stopped. Accordingly, the supply of the refrigerant to the evaporator 17 may be stopped.

In such a state, a portion of the refrigerant line 11 connecting the first end of the first line 32 to the heat-exchanger 15 may be closed by the first valve 51.

A portion of the refrigerant line 11 connecting the first end of the first connection line 21 to the compressor 10 may be opened.

In addition, a portion of the refrigerant line 11 connecting a second end of the first connection line 21 to the evaporator 17 may be closed by the first expansion valve 16.

In addition, a portion of the refrigerant line 11 connecting the evaporator 17 and the first end of the first connection line 21 may be closed.

A portion of the refrigerant line 11 connecting the heat-exchanger 15 and the first end of the second connection line 41 may be closed by the second valve 52.

In an embodiment of the present disclosure, the first line 32 may be opened by the third expansion valve 33. In addition, the second line 34 may be opened.

In addition, the third line 35 may be opened by the fourth expansion valve 36.

The first connection line 21 may be opened by the second expansion valve 23. The second connection line 41 may be opened by the fourth expansion valve 36.

In addition, the third connection line 42 may be closed by the second expansion valve 23. The fourth connection line 43 may be closed by the third expansion valve 33. In addition, the fifth connection line 44 may be closed by the fourth expansion valve 36.

The third expansion valve 33 may expand the refrigerant supplied from the internal condenser 13 through the first line 32. Thereafter, the third expansion valve 33 may supply the expanded refrigerant to the flash tank 31 through the first line 32.

In addition, the fourth expansion valve 36 may flow the refrigerant supplied from the flash tank 31 through the third line 35, to the second connection line 41 without expansion.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34 to increase the flow rate of the refrigerant circulating through the refrigerant line 11.

The refrigerant flowing along the second connection line 41 may pass through the sub-heat-exchanger 60, and then may be introduced into the second expansion valve 23 through a portion of the refrigerant line 11 and the first connection line 21.

The second expansion valve 23 may expand the refrigerant introduced through the first connection line 21. Thereafter, the second expansion valve 23 may supply the expanded refrigerant to the chiller 20.

The refrigerant introduced into the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

The refrigerant having recollected the waste heat of the electrical component 3 at the chiller 20 may sequentially pass through the sub-heat-exchanger 60 and the accumulator 18 along the refrigerant line 11 connected to the first connection line 21, and then may be supplied to the compressor 10.

In other words, the refrigerant having passed through the accumulator 18, and the refrigerant supplied from the flash tank 31 through the second line 34, may be introduced into the compressor 10. The introduced refrigerant may be compressed by the compressor 10.

The refrigerant compressed at the compressor 10 may be supplied to the internal condenser 13 along the refrigerant line 11. The refrigerant supplied to the internal condenser 13 may increase the temperature of the ambient air introduced into the HVAC module 12.

The opening/closing door 14 may be opened so that the ambient air introduced into the HVAC module 12 and having passed through the evaporator 17 passes through the internal condenser 13.

Accordingly, when passing through the evaporator 17 that is not supplied with the refrigerant, the ambient air introduced from the outside may be introduced at a room-temperature state without having been cooled. The introduced ambient air may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 33 through the first line 32, as described above. Thereafter, the refrigerant may be supplied to the flash tank 31 along the first line 32 in a state expanded by the third expansion valve 33.

As such, a heat pump system according to an embodiment of the present disclosure can smoothly recollect the waste heat at the chiller 20 from the coolant having its temperature increased while passing through the electrical component 3 during driving of the vehicle, together with an operation of the gas injection device 30, thereby improving the overall heating performance and efficiency.

In addition, the present disclosure may improve the heating efficiency and performance while minimizing usage of a separate electric heater.

In addition, the gas injection device 30 may increase the flow rate of the refrigerant circulating through the refrigerant line 11, thereby maximizing the heating performance.

In an embodiment of the present disclosure, waste heat of the electrical component 3 is recollected, but is not limited thereto, and at least one of the waste heat of the electrical component 3 or the waste heat of the battery module 5 may be selectively recollected.

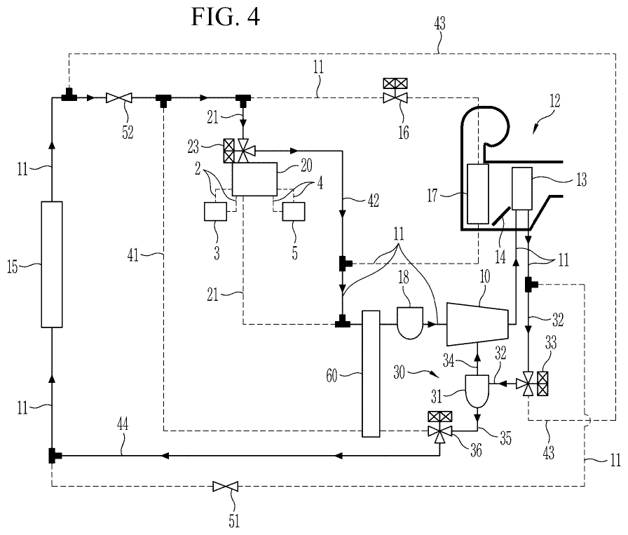

An operation of a heat pump system for a vehicle according to an embodiment of the present disclosure when the gas injection device 30 is operated and the ambient air heat is to be recollected in the heating mode of the vehicle interior is described in detail below with reference to FIG. 4.

FIG. 4 is an operation diagram of a heat pump system for a vehicle according to an embodiment of the present disclosure when the gas injection device is operated and the ambient air heat is to be recollected in the heating mode of the vehicle interior.

Referring to FIG. 4, the heat pump system may absorb the ambient air heat from the ambient air, in the state that the gas injection device 30 is being operated.

In other words, when the gas injection device 30 is operated in the heating mode of the vehicle interior, the operation of the first expansion valve 16 may be stopped. Accordingly, the supply of the refrigerant to the evaporator 17 may be stopped.

In such a state, a portion of the refrigerant line 11 connecting the first end of the first line 32 to the second end of the fifth connection line 44 may be closed by the first valve 51.

A portion of the refrigerant line 11 connecting the heat-exchanger 15 and the second end of the first connection line 21 may be opened by the second valve 52. A portion of the refrigerant line 11 connecting the second end of the first connection line 21 to the evaporator 17 may be closed by the first expansion valve 16.

In addition, a portion of the refrigerant line 11 connecting the evaporator 17 to the second end of the third connection line 42 may be closed.

In addition, a portion of the refrigerant line 11 connecting the second end of the third connection line 42 to the compressor 10 may be opened.

In an embodiment of the present disclosure, the first line 32 may be opened by the third expansion valve 33. In addition, the second line 34 may be opened.

In addition, the third line 35 may be opened by the fourth expansion valve 36.

A portion of the first connection line 21 connecting the refrigerant line 11 and the second expansion valve 23 may be opened by the second expansion valve 23.

A remaining portion of the first connection line 21 connecting the chiller 20 and the refrigerant line 11 connected to the compressor 10 may be closed by the second expansion valve 23.

The second connection line 41 may be closed by the fourth expansion valve 36. In addition, the third connection line 42 may be opened by the second expansion valve 23.

The second expansion valve 23 may flow the refrigerant introduced through a portion of the refrigerant line 11 and the first connection line 21 from the heat-exchanger 15 to the third connection line 42 without expansion.

The fourth connection line 43 may be closed by the third expansion valve 33. In addition, the fifth connection line 44 may be opened by the fourth expansion valve 36.

The third expansion valve 33 may expand the refrigerant supplied from the internal condenser 13 through the first line 32. Thereafter, the third expansion valve 33 may supply the expanded refrigerant to the flash tank 31 through the first line 32.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34 to increase the flow rate of the refrigerant circulating through the refrigerant line 11.

The fourth expansion valve 36 may expand the refrigerant supplied from the flash tank 31 through the third line 35. Thereafter, the fourth expansion valve 36 may flow the expanded refrigerant to the fifth connection line 44.

The refrigerant flowing along the fifth connection line 44 may be introduced into the heat-exchanger 15 along a portion of the refrigerant line 11.

In other words, the liquid refrigerant stored in the flash tank 31 may be expanded through the operation of the fourth expansion valve 36, and may flow to the heat-exchanger 15 along the refrigerant line 11 connected to the fifth connection line 44.

The heat-exchanger 15 may evaporate the refrigerant while heat-exchanging the ambient air and the refrigerant supplied from the fourth expansion valve 36. The refrigerant may directly absorb the ambient air heat from the ambient air.

The refrigerant having passed through the heat-exchanger 15 may be introduced into the second expansion valve 23 along the refrigerant line 11 and the opened first connection line 21. The second expansion valve 23 may flow the refrigerant introduced through the first connection line 21, to the third connection line 42, without expansion.

The first and second coolant lines 2 and 4 may be closed. Accordingly, the coolant does not flow to the chiller 20.

The refrigerant flowing through the third connection line 42 may sequentially pass through the sub-heat-exchanger 60 and the accumulator 18 along the refrigerant line 11. Thereafter, the refrigerant may be supplied to the compressor 10.

In other words, the refrigerant having recollected the ambient air heat while passing through the heat-exchanger 15 may pass through the accumulator 18, and then may be supplied to the compressor 10.

Accordingly, the refrigerant having passed through the accumulator 18, and the refrigerant supplied from the flash tank 31 through the second line 34, may be introduced into the compressor 10. The introduced refrigerant may be compressed by the compressor 10.

The refrigerant compressed at the compressor 10 may be supplied to the internal condenser 13 along the refrigerant line 11. The refrigerant supplied to the internal condenser 13 may increase the temperature of the ambient air introduced into the HVAC module 12.

The opening/closing door 14 may be opened so that the ambient air introduced into the HVAC module 12 and having passed through the evaporator 17 passes through the internal condenser 13.

Accordingly, when passing through the evaporator 17 that is not supplied with the refrigerant, the ambient air introduced from the outside may be introduced at a room-temperature state without having been cooled. The introduced ambient air may be converted to a high-temperature state while passing through the internal condenser 13 and then introduced into the vehicle interior, thereby implementing heating of the vehicle interior.

In addition, the refrigerant condensed at the internal condenser 13 may be supplied to the flash tank 31 along the first line 32 in a state expanded by the third expansion valve 33.

As such, a heat pump system according to an embodiment of the present disclosure can recollect the ambient air heat at the heat-exchanger 15 during driving of the vehicle, together with the operation of the gas injection device 30, thereby improving the overall heating performance and efficiency.

In addition, the present disclosure may improve the heating efficiency and performance while minimizing usage of a separate electric heater.

In addition, the gas injection device 30 may increase the flow rate of the refrigerant circulating through the refrigerant line 11, thereby maximizing the heating performance.

An embodiment of the present disclosure recollects the ambient air heat, but is not limited thereto, and not only the ambient air heat but also the waste heat of the electrical component 3 or the battery module 5 may be recollected together.

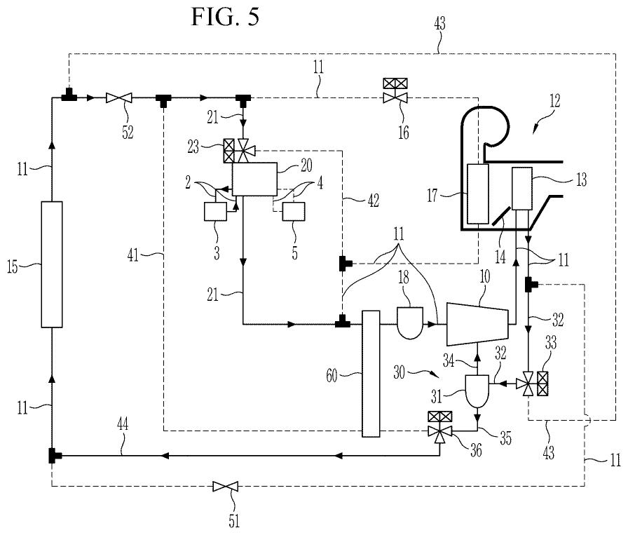

An operation of a heat pump system for a vehicle according to an embodiment of the present disclosure when the gas injection device 30 is operated in the heating mode of the vehicle interior, and the waste heat of the electrical component 3 is to be recollected together with the ambient air heat, is described in detail below with reference to FIG. 5.

FIG. 5 is an operation diagram of a heat pump system for a vehicle according to an embodiment of the present disclosure when the gas injection device is operated and the waste heat of the electrical component and the ambient air heat are to be recollected together in the heating mode of the vehicle interior.

Referring to FIG. 5, the heat pump system may absorb the waste heat of the electrical component 3 and the ambient air heat from the ambient air together, in the state that the gas injection device 30 is being operated.

In other words, when the gas injection device 30 is operated in the heating mode of the vehicle interior, the operation of the first expansion valve 16 may be stopped. Accordingly, the supply of the refrigerant to the evaporator 17 may be stopped.

In such a state, a portion of the refrigerant line 11 connecting the first end of the first line 32 to the second end of the fifth connection line 44 may be closed by the first valve 51.

A portion of the refrigerant line 11 connecting the heat-exchanger 15 and the second end of the first connection line 21 may be opened by the second valve 52. A portion of the refrigerant line 11 connecting the second end of the first connection line 21 to the evaporator 17 may be closed by the first expansion valve 16.

In addition, a portion of the refrigerant line 11 connecting the evaporator 17 to the first end of the first connection line 21 may be closed. In addition, a portion of the refrigerant line 11 connecting the first end of the first connection line 21 to the compressor 10 may be opened.

In an embodiment of the present disclosure, the first line 32 may be opened by the third expansion valve 33. In addition, the second line 34 may be opened.

In addition, the third line 35 may be opened by the fourth expansion valve 36.

The first connection line 21 may be opened by the second expansion valve 23. The second connection line 41 may be closed by the fourth expansion valve 36. In addition, the third connection line 42 may be closed by the second expansion valve 23.

The fourth connection line 43 may be closed by the third expansion valve 33. In addition, the fifth connection line 44 may be opened by the fourth expansion valve 36.

The third expansion valve 33 may expand the refrigerant supplied from the internal condenser 13 through the first line 32. Thereafter, the third expansion valve 33 may supply the expanded refrigerant to the flash tank 31 through the first line 32.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34 to increase the flow rate of the refrigerant circulating through the refrigerant line 11.

The fourth expansion valve 36 may expand the refrigerant supplied from the flash tank 31 through the third line 35. Thereafter, the fourth expansion valve 36 may flow the expanded refrigerant to the fifth connection line 44.

The refrigerant flowing along the fifth connection line 44 may be introduced into the heat-exchanger 15 along a portion of the refrigerant line 11.

In other words, the liquid refrigerant stored in the flash tank 31 may be expanded through the operation of the fourth expansion valve 36, and may flow to the heat-exchanger 15 along the refrigerant line 11 connected to the fifth connection line 44.

The heat-exchanger 15 may evaporate the refrigerant while heat-exchanging the ambient air and the refrigerant supplied from the fourth expansion valve 36. The refrigerant may directly absorb the ambient air heat from the ambient air.

The refrigerant having passed through the heat-exchanger 15 may be introduced into the second expansion valve 23 along the refrigerant line 11 and the opened first connection line 21.

The second expansion valve 23 may supply the refrigerant introduced through a portion of the refrigerant line 11 and the first connection line 21 from the heat-exchanger 15 to the chiller 20 without expansion.

The refrigerant introduced into the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

The refrigerant having recollected the waste heat of the electrical component 3 at the chiller 20 may sequentially pass through the sub-heat-exchanger 60 and the accumulator 18 along the refrigerant line 11 connected to the first connection line 21, and then may be supplied to the compressor 10.

In other words, the refrigerant having passed through the accumulator 18, and the refrigerant supplied from the flash tank 31 through the second line 34, may be introduced into the compressor 10. The introduced refrigerant may be compressed by the compressor 10.

The refrigerant compressed at the compressor 10 may be supplied to the internal condenser 13 along the refrigerant line 11. The refrigerant supplied to the internal condenser 13 may increase the temperature of the ambient air introduced into the HVAC module 12.

The opening/closing door 14 may be opened so that the ambient air introduced into the HVAC module 12 and having passed through the evaporator 17 passes through the internal condenser 13.

Accordingly, when passing through the evaporator 17 that is not supplied with the refrigerant, the ambient air introduced from the outside may be introduced at a room-temperature state without having been cooled. The introduced ambient air may be converted to a high-temperature state while passing through the internal condenser 13 and then introduced into the vehicle interior, thereby implementing heating of the vehicle interior.

In addition, the refrigerant condensed at the internal condenser 13 may be introduced into the third expansion valve 33 through the first line 32, as described above. Thereafter, the refrigerant may be supplied to the flash tank 31 along the first line 32 in a state expanded by the third expansion valve 33.

As such, a heat pump system according to an embodiment of the present disclosure may smoothly recollect the waste heat at the chiller 20 from the coolant having its temperature increased while passing through the electrical component 3 during driving of the vehicle, together with the operation of the gas injection device 30.

The heat pump system may recollect the ambient air heat at the heat-exchanger 15, thereby improving the overall heating performance and efficiency.

In addition, the present disclosure may improve the heating efficiency and performance while minimizing usage of a separate electric heater.

In addition, the gas injection device 30 may increase the flow rate of the refrigerant circulating through the refrigerant line 11, thereby maximizing the heating performance.

In an embodiment of the present disclosure, the ambient air heat and the waste heat of the electrical component 3 are recollected together, but is not limited thereto, and at least one of the waste heat of the electrical component 3 or the waste heat of the battery module 5 may be selectively recollected.

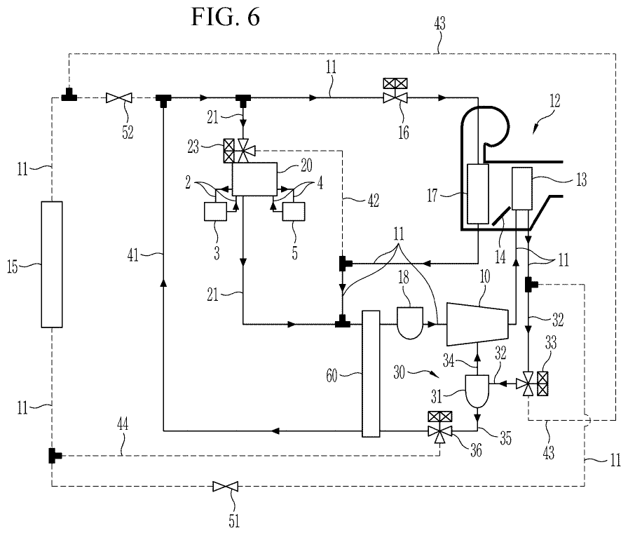

An operation of a heat pump system for a vehicle according to an embodiment of the present disclosure when the gas injection device 30 is operated in the heating and dehumidifying mode of the vehicle interior is described in detail below with reference to FIG. 6.

FIG. 6 is an operation diagram of a heat pump system for a vehicle according to an embodiment of the present disclosure when the gas injection device is operated in the heating and dehumidifying mode of the vehicle interior.

Referring to FIG. 6, a portion of the refrigerant line 11 connecting the evaporator 17 and the compressor 10 may be opened. At the same time, a portion of the refrigerant line 11 connecting the second end of the first connection line 21 to the evaporator 17 may be opened by the first expansion valve 16.

In addition, a portion of the refrigerant line 11 connecting the first end of the first line 32 to the heat-exchanger 15 may be closed by the first valve 51. In addition, a portion of the refrigerant line 11 connecting the heat-exchanger 15 and the first end of the second connection line 41 may be closed by the second valve 52.

In an embodiment of the present disclosure, the first line 32 may be opened by the third expansion valve 33. In addition, the second line 34 may be opened.

In addition, the third line 35 may be opened by the fourth expansion valve 36.

The first connection line 21 may be opened by the second expansion valve 23. The second connection line 41 may be opened by the fourth expansion valve 36.

In addition, the third connection line 42 may be closed by the second expansion valve 23. The fourth connection line 43 may be closed by the third expansion valve 33. In addition, the fifth connection line 44 may be closed by the fourth expansion valve 36.

The third expansion valve 33 may expand the refrigerant supplied from the internal condenser 13 through the first line 32. Thereafter, the third expansion valve 33 may supply the expanded refrigerant to the flash tank 31 through the first line 32.

In addition, the fourth expansion valve 36 may flow the refrigerant supplied from the flash tank 31 through the third line 35 to the second connection line 41 without expansion.

Accordingly, the flash tank 31 may supply the gaseous refrigerant among the interiorly introduced refrigerant to the compressor 10 through the opened second line 34.

In other words, the gas injection device 30 may flow the gaseous refrigerant separated while passing through the flash tank 31 back to the compressor 10 through the second line 34 to increase the flow rate of the refrigerant circulating through the refrigerant line 11.

The refrigerant flowing along the second connection line 41 may pass through the sub-heat-exchanger 60.

A partial refrigerant among the refrigerant having passed through the sub-heat-exchanger 60 may be introduced into the second expansion valve 23 along the second connection line 41, a portion of the refrigerant line 11, and the first connection line 21.

The second expansion valve 23 may expand the refrigerant introduced through the first connection line 21. Thereafter, the second expansion valve 23 may supply the expanded refrigerant to the chiller 20.

The refrigerant supplied to the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

A remaining refrigerant among the refrigerant having passed through the sub-heat-exchanger 60 may be introduced into the first expansion valve 16 along the refrigerant line 11. The first expansion valve 16 may expand the refrigerant introduced through the refrigerant line 11 and supply the expanded refrigerant to the evaporator 17.

The refrigerant having passed through the evaporator 17 and the chiller 20, respectively, may pass through the sub-heat-exchanger 60 along the refrigerant line 11.

The sub-heat-exchanger 60 may additionally condense the refrigerant supplied from the flash tank 31 through the second connection line 41 through heat-exchange with the refrigerant supplied from the evaporator 17 and the chiller 20, respectively.

The refrigerant supplied from the evaporator 17 and the chiller 20 and having passed through the sub-heat-exchanger 60 may be introduced into the accumulator 18 along the refrigerant line 11. Thereafter, the refrigerant may pass through the accumulator 18 to be supplied to the compressor 10.

In other words, the refrigerant having passed through the accumulator 18, and the refrigerant supplied from the flash tank 31 through the second line 34, may be introduced into the compressor 10. The introduced refrigerant may be compressed by the compressor 10.

The refrigerant compressed at the compressor 10 may be supplied to the internal condenser 13 along the refrigerant line 11. The refrigerant supplied to the internal condenser 13 may increase the temperature of the ambient air introduced into the HVAC module 12.

The opening/closing door 14 may be opened so that the ambient air introduced into the HVAC module 12 and having passed through the evaporator 17 passes through the internal condenser 13.

The air introduced into the HVAC module 12 may be dehumidified while passing through the evaporator 17 by the low-temperature refrigerant introduced into the evaporator 17.

Then, the dehumidified air may be converted to a high-temperature state while passing through the internal condenser 13 and introduced into the vehicle interior, thereby smoothly heating and dehumidifying the vehicle interior.

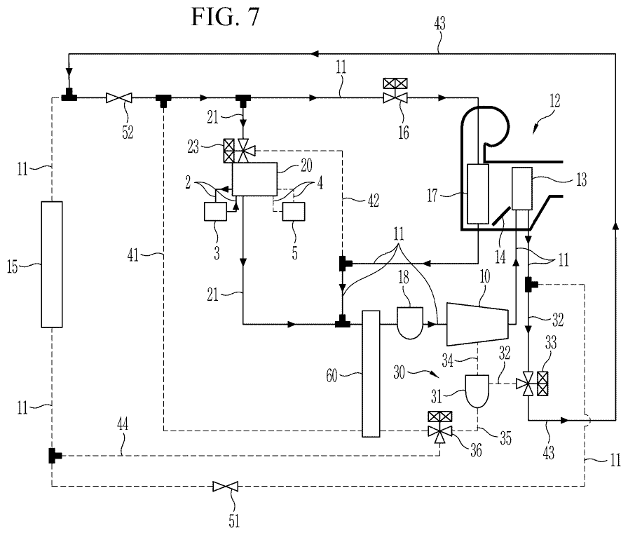

An operation of a heat pump system for a vehicle according to an embodiment of the present disclosure when the gas injection device 30 is not operated in the heating and dehumidifying mode of the vehicle interior is described in detail below with reference to FIG. 7.

FIG. 7 is an operation diagram of a heat pump system for a vehicle according to an embodiment of the present disclosure when the gas injection device is not operated in the heating and dehumidifying mode of the vehicle interior.

Referring to FIG. 7, a portion of the refrigerant line 11 connecting the evaporator 17 and the compressor 10 may be opened. At the same time, a portion of the refrigerant line 11 connecting the second end of the first connection line 21 to the evaporator 17 may be opened by the first expansion valve 16.

In addition, a portion of the refrigerant line 11 connecting the first end of the first line 32 to the heat-exchanger 15 may be closed by the first valve 51. In addition, a portion of the refrigerant line 11 connecting the heat-exchanger 15 to the first end of the fourth connection line 43 may be closed.

A portion of the refrigerant line 11 connecting the first end of the fourth connection line 43 to the first expansion valve 16 may be opened by the second valve 52.

In an embodiment of the present disclosure, a portion of the first line 32 may be opened by the third expansion valve 33 so that the internal condenser 13 may be connected to the third expansion valve 33.

In addition, the remaining portion of the first line 32 connecting the flash tank 31 and the third expansion valve 33 may be closed by the third expansion valve 33. In addition, the second line 34 may be closed.

In an embodiment of the present disclosure, the third line 35 may be closed by the fourth expansion valve 36. Accordingly, the operation of the flash tank 31 and the fourth expansion valve 36 may be stopped.

The first connection line 21 may be opened by the second expansion valve 23. The second connection line 41 may be closed by the fourth expansion valve 36.

In addition, the third connection line 42 may be closed by the second expansion valve 23. The fourth connection line 43 may be opened by the third expansion valve 33. In addition, the fifth connection line 44 may be closed by the fourth expansion valve 36.

Accordingly, the refrigerant discharged from the internal condenser 13 may be introduced into the third expansion valve 33 through a portion of the refrigerant line 11 and the first line 32.

The third expansion valve 33 may flow the refrigerant supplied from the internal condenser 13 through the first line 32, to the fourth connection line 43 without expansion.

A partial refrigerant among the refrigerant flowing along the fourth connection line 43 may be introduced into the second expansion valve 23 through a portion of the refrigerant line 11 and the first connection line 21.

The second expansion valve 23 may expand the refrigerant introduced through the first connection line 21. Thereafter, the second expansion valve 23 may supply the expanded refrigerant to the chiller 20.

The refrigerant supplied to the chiller 20 may cool the coolant while heat-exchanging with the coolant supplied from the electrical component 3 through the first coolant line 2.

The coolant may have its temperature increased by recollecting the waste heat from the electrical component 3 while cooling the electrical component 3. The coolant having its temperature increased through such an operation may be supplied to the chiller 20.

The chiller 20 may recollect the waste heat of the electrical component 3 while heat-exchanging the coolant supplied from the electrical component 3 through the first coolant line 2 with the refrigerant.

A remaining refrigerant among the refrigerant flowing along the fourth connection line 43 may be introduced into the first expansion valve 16 along the refrigerant line 11. The first expansion valve 16 may expand the refrigerant introduced through the refrigerant line 11 and supply the expanded refrigerant to the evaporator 17.

The refrigerant having passed through the evaporator 17 and the chiller 20, respectively, may sequentially pass through the sub-heat-exchanger 60 and the accumulator 18 along the refrigerant line 11. Thereafter, the refrigerant may be supplied to the compressor 10.

In other words, only the refrigerant having passed through the accumulator 18 can be introduced into the compressor 10. The introduced refrigerant may be compressed by the compressor 10.

The refrigerant compressed at the compressor 10 may be supplied to the internal condenser 13 along the refrigerant line 11. The refrigerant supplied to the internal condenser 13 may increase the temperature of the ambient air introduced into the HVAC module 12.

The opening/closing door 14 may be opened such that the ambient air introduced into the HVAC module 12 and having passed through the evaporator 17 may pass through the internal condenser 13. The air introduced into the HVAC module 12 may be dehumidified while passing through the evaporator 17 by the low-temperature refrigerant introduced into the evaporator 17.

Then, the dehumidified air may be converted to a high-temperature state while passing through the internal condenser 13 and introduced into the vehicle interior, and the vehicle interior may be smoothly heated and dehumidified without the operation of the gas injection device 30.

Therefore, as described above, according to a heat pump system for a vehicle according to an embodiment of the present disclosure, by using one chiller 20 where the coolant and the refrigerant are heat-exchanged, the waste heat of the electrical component 3 and the battery module 5 may be recollected depending on the air conditioning mode of the vehicle interior, and the temperature of the battery module 5 may be adjusted.

In addition, the present disclosure may increase the flow rate of the refrigerant by applying the gas injection device 30 selectively operating in the selected air conditioning mode of the vehicle interior, thereby improving the cooling and heating performance of the system.

In addition, according to the present disclosure, the performance of the system by using the gas injection device 30 may be maximized while minimizing the required system components, and accordingly, streamlining and simplification of the system may be achieved.

In addition, according to an embodiment of the present disclosure, by efficiently adjusting the temperature of the battery module 5, the optimal performance of the battery module 5 may be enabled, and the overall travel distance of the vehicle may be increased due to the efficient management of the battery module 5.

In addition, the present disclosure may improve heating efficiency by selectively using the heat from an external heat source or the waste heat of the electrical component 3 in the heating mode of the vehicle interior.

In addition, according to the present disclosure, through streamlining of an entire system, it is possible to reduce manufacturing cost and weight and improve space utilization of the system and the vehicle.

While this disclosure has been described in connection with what is presently considered to be practical embodiments of the present disclosure, it is to be understood that the disclosure is not limited to the disclosed embodiments. On the contrary, the present disclosure is intended to cover various modifications and equivalent arrangements included within the spirit and scope of the appended claims.

### DESCRIPTION OF SYMBOLS

2: first coolant line
3: electrical component
4: second coolant line
5: battery module
10: compressor
11: refrigerant line
12: HVAC module
13: internal condenser
14: opening/closing door
15: heat-exchanger
16: first expansion valve
17: evaporator
18: accumulator
20: chiller
21: first connection line
23: second expansion valve
30: gas injection device
31: flash tank
32: first line
33: third expansion valve
34, 35: second and third lines
36: fourth expansion valve
41: second connection line
42: third connection line
43: fourth connection line
44: fifth connection line
51, 52: first and second valves
60: sub-heat-exchanger

What is claimed is:

1. A heat pump system for a vehicle, the heat pump system comprising:
a compressor configured to compress a refrigerant;
an HVAC module including an internal condenser and an evaporator connected to the compressor through a refrigerant line, and an opening/closing door configured to adjust air having passed through the evaporator to be selectively introduced into the internal condenser based on cooling or heating of a vehicle interior;
a heat-exchanger connected to the internal condenser through the refrigerant line, the heat exchanger configured to condense or evaporate the refrigerant by exchanging heat between the refrigerant and air;
a first expansion valve provided on the refrigerant line between the heat-exchanger and the evaporator;
a first connection line disposed between the compressor and the evaporator, the first connection line having a first end connected to the refrigerant line and a second end connected to the refrigerant line between the heat-exchanger and the first expansion valve;
a chiller provided on the first connection line, the chiller configured to exchange heat between the refrigerant introduced through the first connection line and a coolant to adjust a temperature of the coolant;
a second expansion valve provided on the first connection line at an upstream end of the chiller;
a gas injection device connected to the refrigerant line between the internal condenser and the heat-exchanger, the gas injection device configured to selectively expand the refrigerant supplied from the internal condenser or the heat-exchanger and flow the refrigerant expanded by the gas injection device and selectively supply a partial refrigerant among the refrigerant supplied to the gas injection device to the compressor to increase a flow rate of the refrigerant circulating through the refrigerant line;
a second connection line having a first end connected to the refrigerant line between the heat-exchanger and the first expansion valve and a second end connected to the gas injection device;
a third connection line having a first end connected to the second expansion valve and a second end connected to the refrigerant line between the evaporator and the compressor; and
a fourth connection line having a first end connected to the refrigerant line between the heat-exchanger and the first end of the second connection line and a second end connected to the gas injection device.

2. The heat pump system of claim 1, wherein the gas injection device comprises:
a flash tank configured to separate the refrigerant into a gaseous refrigerant and a liquid refrigerant and selectively discharge the gaseous refrigerant and the liquid refrigerant;
a first line having a first end connected to the refrigerant line between the internal condenser and the heat-exchanger and a second end connected to the flash tank;
a third expansion valve provided on the first line;
a second line connecting the compressor and the flash tank, the second line configured to selectively supply the gaseous refrigerant from the flash tank to the compressor;
a third line having a first end connected to the flash tank; and
a fourth expansion valve connected to a second end of the third line and a second end of the second connection line, the fourth expansion valve configured to selectively expand the refrigerant discharged from the flash tank through the third line.

3. The heat pump system of claim 2, wherein the fourth expansion valve is configured to:
selectively expand the refrigerant supplied from the flash tank and supply the refrigerant expanded by the fourth expansion valve to the heat-exchanger; or
supply the refrigerant supplied from the flash tank to the first expansion valve, the second expansion valve, or a combination thereof, without expansion.

4. The heat pump system of claim 2, wherein the third expansion valve and the fourth expansion valve are configured to selectively operate in a cooling mode, a heating mode, or a heating and dehumidifying mode of the vehicle interior, and selectively expand the refrigerant while controlling a flow direction of the refrigerant.

5. The heat pump system of claim 2, wherein the flash tank is configured to operate when the refrigerant expanded by the third expansion valve is supplied from the third expansion valve through the first line, and wherein the flash tank is further configured to supply the gaseous refrigerant among the refrigerant supplied to the compressor through the second line, to increase the flow rate of the refrigerant circulating through the refrigerant line.

6. The heat pump system of claim 2, wherein a second end of the fourth connection line is connected to the third expansion valve.

7. The heat pump system of claim 2, further comprising:
a fifth connection line having a first end connected to the fourth expansion valve and a second end connected to the refrigerant line at a downstream end of the heat-exchanger;
a first valve provided on the refrigerant line between the internal condenser and the heat-exchanger; and
a second valve provided on the refrigerant line between the first end of the second connection line and a first end of the fourth connection line.

8. The heat pump system of claim 7, wherein, when the gas injection device is operated, and cooling of a battery module is required in a cooling mode of the vehicle interior:
a portion of the refrigerant line connecting the internal condenser and the heat-exchanger is configured to be opened by the first valve;
a portion of the refrigerant line connecting a first end of the fourth connection line and the first end of the second connection line is configured to be closed by the second valve;
a portion of the first line connecting the refrigerant line to the third expansion valve is configured to be closed;
a remaining portion of the first line connecting the third expansion valve to the flash tank is configured to be opened;
the second line is configured to be opened;
the third line is configured to be opened by the fourth expansion valve;
the first connection line is configured to be opened by the second expansion valve;
the second connection line is configured to be opened by the fourth expansion valve;
the third connection line is configured to be closed by the second expansion valve;
the fourth connection line is configured to be opened by the third expansion valve;
the fifth connection line is configured to be closed by the fourth expansion value;
the first expansion valve is configured to expand the refrigerant introduced through the second connection line and a portion of the refrigerant line from the flash tank, and the first expansion valve is configured to supply the refrigerant expanded by the first expansion valve to the evaporator;
the second expansion valve is configured to expand the refrigerant introduced through the second connection line, a portion of the refrigerant line, and the first connection line, and the second expansion valve is configured to supply the refrigerant expanded by the second expansion valve to the chiller;
the third expansion valve is configured to expand the refrigerant introduced through a portion of the refrigerant line and the fourth connection line from the heat-exchanger, and the third expansion valve is configured to supply the refrigerant expanded by the third expansion valve to the first line;
the fourth expansion valve is configured to flow the refrigerant supplied from the flash tank through the third line to the second connection line without expansion; and
the flash tank is configured to supply the gaseous refrigerant among the refrigerant to the compressor through the opened second line.

9. The heat pump system of claim 7, wherein, when the gas injection device is operated and a waste heat of an electrical component is to be recollected in a heating mode of the vehicle interior:
a portion of the refrigerant line connecting the first end of the first line to the heat-exchanger is configured to be closed by the first valve;
a portion of the refrigerant line connecting the first end of the first connection line to the compressor is configured to be opened;
a portion of the refrigerant line connecting the second end of the first connection line to the evaporator is configured to be closed by the first expansion valve;
a portion of the refrigerant line connecting the evaporator and the first end of the first connection line is configured to be closed;
a portion of the refrigerant line connecting the heat-exchanger and the first end of the second connection line is configured to be closed by the second valve;
the first line is configured to be opened by the third expansion valve;
the second line is configured to be opened;
the third line is configured to be opened by the fourth expansion valve;
the first connection line is configured to be opened by the second expansion valve;
the second connection line is configured to be opened by the fourth expansion valve;
the third connection line is configured to be closed by the second expansion valve;
the fourth connection line is configured to be closed by the third expansion valve;
the fifth connection line is configured to be closed by the fourth expansion valve;
an operation of the first expansion valve is configured to be stopped;
the second expansion valve is configured to expand the refrigerant introduced from the flash tank through the second connection line, a portion of the refrigerant line, and the first connection line, and the second expansion valve is configured to supply the refrigerant expanded by the second expansion valve to the chiller;
the third expansion valve is configured to expand the refrigerant supplied from the internal condenser, and the third expansion valve is configured to supply the refrigerant expanded by the third expansion valve to the flash tank through the first line;
the fourth expansion valve is configured to flow the refrigerant supplied from the flash tank through the third line to the second connection line without expansion;
the flash tank is configured to supply the gaseous refrigerant among the refrigerant to the compressor through the opened second line.

10. The heat pump system of claim 7, wherein, when the gas injection device is operated and an ambient air heat is to be recollected in a heating mode of the vehicle interior;
a portion of the refrigerant line connecting the first end of the first line to the second end of the fifth connection line is configured to be closed by the first valve;
a portion of the refrigerant line connecting the heat-exchanger and the second end of the first connection line is configured to be opened by the second valve;
a portion of the refrigerant line connecting the second end of the first connection line to the evaporator is configured to be closed by the first expansion valve;
a portion of the refrigerant line connecting the evaporator to a second end of the third connection line is configured to be closed;
a portion of the refrigerant line connecting the second end of the third connection line to the compressor is configured to be opened;
the first line is configured to be opened by the third expansion valve;
the second line is configured to be opened;
the third line is configured to be opened by the fourth expansion valve;
a portion of the first connection line connecting the refrigerant line and the second expansion valve is configured to be opened by the second expansion valve;
a remaining portion of the first connection line connecting the refrigerant line and the chiller connected to the compressor is configured to be closed by the second expansion valve;
the second connection line is configured to be closed by the fourth expansion valve;
the third connection line is configured to be opened by the second expansion valve;
the fourth connection line is configured to be closed by the third expansion valve;
the fifth connection line is configured to be opened by the fourth expansion valve;
an operation of the first expansion valve is configured to be stopped;
the second expansion valve is configured to flow the refrigerant introduced through a portion of the refrigerant line and the first connection line from the heat-exchanger to the third connection line without expansion;
the third expansion valve is configured to expand the refrigerant supplied from the internal condenser, and the third expansion valve is configured to supply the refrigerant expanded from the third expansion valve to the flash tank through the first line;
the fourth expansion valve is configured to expand the refrigerant supplied from the flash tank through the third line, and the fourth expansion valve is configured to flow the refrigerant expanded by the fourth expansion valve to the fifth connection line;
the flash tank is configured to supply the gaseous refrigerant among the refrigerant to the compressor through the opened second line.

11. The heat pump system of claim 7, wherein, when the gas injection device is operated and a waste heat of an electrical component and an ambient air heat are recollected together in a heating mode of the vehicle interior:
a portion of the refrigerant line connecting the first end of the first line to a second end of the fifth connection line is configured to be closed by the first valve;
a portion of the refrigerant line connecting the heat-exchanger and the second end of the first connection line is configured to be opened by the second valve;
a portion of the refrigerant line connecting the second end of the first connection line to the evaporator is configured to be closed by the first expansion valve;
a portion of the refrigerant line connecting the evaporator to the first end of the first connection line is configured to be closed;
a portion of the refrigerant line connecting the first end of the first connection line to the compressor is configured to be opened;
the first line is configured to be opened by the third expansion valve;
the second line is configured to be opened;
the third line is configured to be opened by the fourth expansion valve;
the first connection line is configured to be opened by the second expansion valve;
the second connection line is configured to be closed by the fourth expansion valve;
the third connection line is configured to be closed by the second expansion valve;
the fourth connection line is configured to be closed by the third expansion the fifth connection line is configured to be opened by the fourth expansion valve;
an operation of the first expansion valve is configured to be stopped;
the second expansion valve is configured to supply the refrigerant introduced through a portion of the refrigerant line and the first connection line from the heat-exchanger to the chiller without expansion;
the third expansion valve is configured to expand the refrigerant supplied from the internal condenser, and the third expansion valve is configured to supply the refrigerant expanded by the third expansion valve to the flash tank through the first line;
the fourth expansion valve is configured to expand the refrigerant supplied from the flash tank through the third line, and the fourth expansion valve is configured to flow the refrigerant expanded by the fourth expansion valve to the fifth connection line;
the flash tank is configured to supply the gaseous refrigerant among the refrigerant to the compressor through the opened second line.

12. The heat pump system of claim 7, wherein, when the gas injection device is operated in a heating and dehumidifying mode of the vehicle interior:
a portion of the refrigerant line connecting the evaporator and the compressor is configured to be opened;
a portion of the refrigerant line connecting the second end of the first connection line to the evaporator is configured to be opened by the first expansion a portion of the refrigerant line connecting the first end of the first line to the heat-exchanger is configured to be closed by the first valve;
a portion of the refrigerant line connecting the heat-exchanger and the first end of the second connection line is configured to be closed by the second valve;
the first line is configured to be opened by the third expansion valve;
the second line is configured to be opened;
the third line is configured to be opened by the fourth expansion valve;
the first connection line is configured to be opened by the second expansion valve;
the second connection line is configured to be opened by the fourth expansion valve;
the third connection line is configured to be closed by the second expansion valve;
the fourth connection line is configured to be closed by the third expansion valve;
the fifth connection line is configured to be closed by the fourth expansion valve;
the first expansion valve is configured to expand the refrigerant introduced through the second connection line and a portion of the refrigerant line from the flash tank, and the first expansion valve is configured to supply the refrigerant expanded by the first expansion valve to the evaporator;
the second expansion valve is configured to expand the refrigerant introduced through the first connection line, and the second expansion valve is configured to supply the refrigerant expanded by the second expansion valve to the chiller;
the third expansion valve is configured to expand the refrigerant supplied from the internal condenser, and the third expansion valve is configured to supply the refrigerant expanded by the third expansion valve to the flash tank through the first line;
the fourth expansion valve is configured to flow the refrigerant supplied from the flash tank through the third line to the second connection line without expansion;
the flash tank is configured to supply the gaseous refrigerant among the refrigerant to the compressor through the opened second line.

13. The heat pump system of claim 7, wherein, when the gas injection device is not operated in a heating and dehumidifying mode of the vehicle interior:
a portion of the refrigerant line connecting the evaporator and the compressor is configured to be opened;
a portion of the refrigerant line connecting the second end of the first connection line to the evaporator is configured to be opened by the first expansion valve;
a portion of the refrigerant line connecting the first end of the first line to the heat-exchanger is configured to be closed by the first valve;
a portion of the refrigerant line connecting the heat-exchanger to the first end of the fourth connection line is configured to be closed;
a portion of the refrigerant line connecting the first end of the fourth connection line to the first expansion valve is configured to be opened by the second valve;
a portion of the first line is configured to be opened by the third expansion valve so that the internal condenser is configured to be connected to the third expansion valve;
a remaining portion of the first line configured to connect the flash tank and the third expansion valve is configured to be closed by the third expansion valve;
the second line is configured to be closed;
the third line is configured to be closed by the fourth expansion valve;
the first connection line is configured to be opened by the second expansion valve;
the second connection line is configured to be closed by the fourth expansion valve;
the third connection line is configured to be closed by the second expansion valve;
the fourth connection line is configured to be opened by the third expansion valve;
the fifth connection line is configured to be closed by the fourth expansion the first expansion valve is configured to expand the refrigerant introduced from the internal condenser through a portion of the first line, the fourth connection line, and a portion of the refrigerant line, and the first expansion valve is configured to supply the refrigerant expanded by the first expansion valve to the evaporator;
the second expansion valve is configured to expand the refrigerant introduced through the first connection line, and the second expansion valve is configured to supply the refrigerant expanded by the second expansion valve to the chiller;
the third expansion valve is configured to flow the refrigerant supplied from the internal condenser to the fourth connection line without expansion; and
an operation of the flash tank and an operation of the fourth expansion valve are stopped.

14. The heat pump system of claim 7, wherein, while the gas injection device is operated, when an ambient air heat is to be recollected in a heating mode of the vehicle interior or when a waste heat of an electrical component and the ambient air heat are to be recollected together in the heating mode of the vehicle interior, the fifth connection line is configured to be opened by the fourth expansion valve.

15. The heat pump system of claim 2, wherein the second expansion valve, the third expansion valve, and the fourth expansion valve are 3-way electronic expansion valves configured to selectively expand the refrigerant while controlling a flow direction of the refrigerant.

16. The heat pump system of claim 2, wherein, when the gas injection device is operated in a cooling mode of the vehicle interior or when the gas injection device is not operated in a heating and dehumidifying mode of the vehicle interior, the fourth connection line is configured to be opened by an operation of the third expansion valve.

17. The heat pump system of claim 1, further comprising a sub-heat-exchanger connected to the second connection line and the refrigerant line connecting the evaporator and the compressor, the sub-heat-exchanger being configured to exchange heat between the refrigerant supplied through the second connection line and the refrigerant supplied from the evaporator or the chiller.

18. The heat pump system of claim 1, wherein, when an ambient air heat is to be recollected in a heating mode of the vehicle interior, the third connection line is configured to be selectively opened by the second expansion valve.

19. The heat pump system of claim 1, further comprising a cooling apparatus comprising an electrical component and a battery module through which the coolant circulates,
wherein the chiller is connected to the electrical component through a first coolant line through which the coolant circulates, the chiller being connected to the battery module through a second coolant line through which the coolant circulates.

20. The heat pump system of claim 19, wherein:
the first coolant line is configured to be opened to connect the chiller and the electrical component, when a waste heat of the electrical component is to be recollected in a heating mode of the vehicle interior;
the second coolant line is configured to be opened to connect the chiller and the battery module, when the battery module is to be cooled in a cooling mode of the vehicle, or when a waste heat of the battery module is to be recollected in the heating mode of the vehicle interior.
